(19) United States
(12) Patent Application Publication
(10) Pub. No.: US 2012/0113891 A1
(43) Pub. Date: May 10, 2012

(54) Vogarwit access system

(76) Inventor: Robert Steven Frazier, Martinsburg, WV (US)

(21) Appl. No.: 12/927,091

(22) Filed: Nov. 8, 2010

(51) Int. Cl. H04W 88/02; H04W 88/08

(52) U.S. Cl. 370/328

(57) ABSTRACT

The Vogarwit functions like a cell phone but relying on Wireless, VOIP and Broadband. The wireless uses open unsecured networks or those for sell. Security bypass technology for wireless access on the remote unit becomes a functional part of the unit later. VOIP gateways will include a Host Service Application that functions over IP using TCP as the transport protocol announcing an available service with a name set by the user and a unique MAC statically coded in the host application obtained from the MAC of the second MC located on the VOIP gateway. The VOIP gateway will be plugged into a local IP network twice; the local network will have a broadband connection with a configured router. The remote handheld will access the internet then connect to its unique service host. The host will provide the dial tone virtually connecting the remote handheld to the users home phone system.

### GENERAL OVERVIEW

The Vogarwit System will make use of three new technologies, wireless internet access, voice over internet protocol and broadband to bring to the user a new form of remote phone service. This service will extent the users own home phone system to their hotel room or pocket anywhere in the world. This system will use these three technologies as well as current computer technologies to bring to bare a product that will compete directly with cell phone technologies.

### HOST SERVICE APPLICATION

The host service, remote client and setup applications will all have their specific functions and will work in unison with each other using the host layers of the OSI model. The host service application, firmware on an IC (integrated circuit) chip located inside the gateway, is responsible for connecting the client and coordinating setup utilities as well as connecting the client handset to a dial tone. It will allow direct connect (dynamic) or login access (static) with the handset and interpret configuration commands from the setup utility.

The full host service itself will contain its own cryptography including an interface with both static and dynamic login security that will allow connection to the VOIP gateway from an external internet connection, specifically the handset. This connection will be obtain in the same fashion all internet applications function across the internet using port assignment for protocol management, port forwarding, and Server/Client application design for connection functions. The Vogarwit host application will exist as firmware in the VOIP gateway but since the gateway itself will be providing two services a separate IP address will be needed for the Vogarwit host application apart from the gateway itself for port forwarding. This IP will be set by the setup utility since it will need to be part of the local network address scheme.

Host setup facilities will be through a third application emulating a phone loaded on a local computer residing in the same local network that the VOIP Gateway resides. This setup utility will be responsible for communicating with the service and providing user configuration input. It will also function in a limited way as a telephone interface where you could make phone calls directly from the computer the setup utility is loaded on.

### GATEWAY

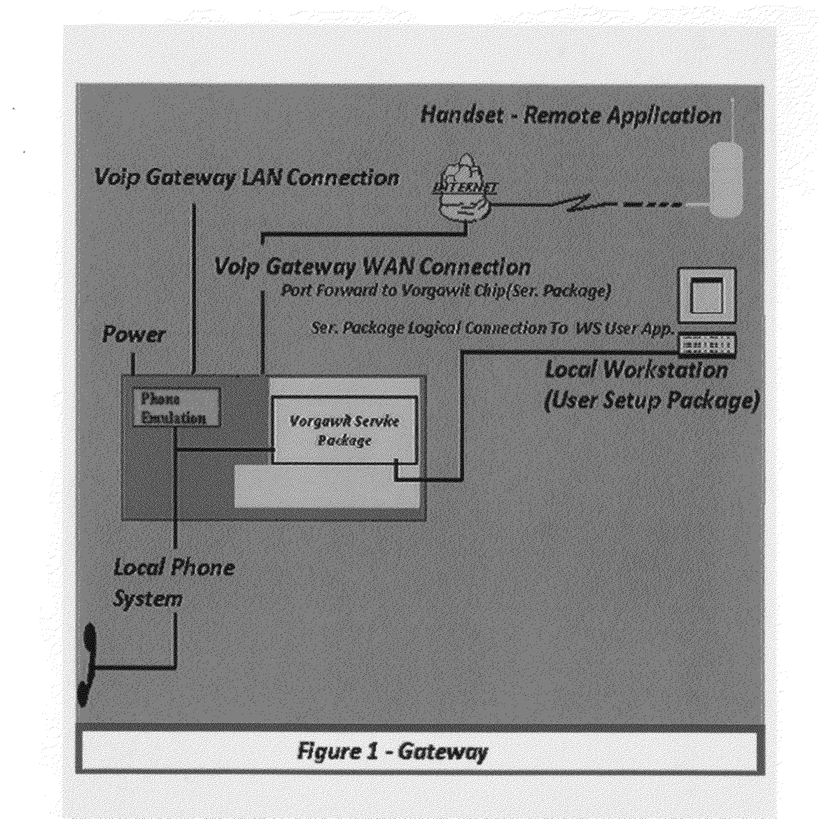

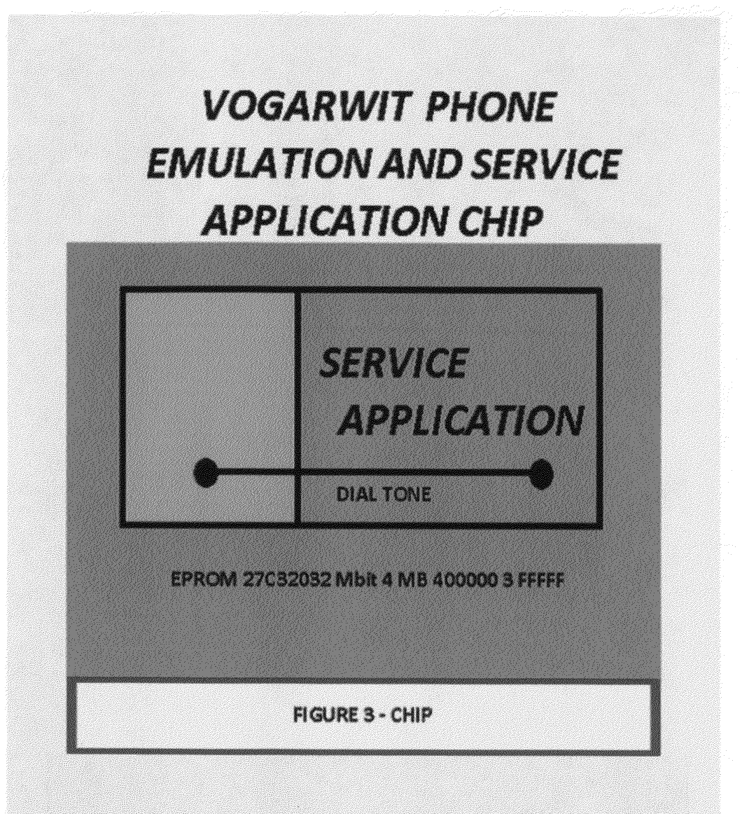

The physical look of the gateway unit (see FIG. 1) will be whatever the VOIP manufacturer wish however it will be set apart from current gateways. Internally it will be very different to accommodate the host service chip (see FIG. 3) onto the system bus. This chip will contain the service application as part of the back end and be responsible for connecting the remote handset then passing the dial tone. The front end of the chip will communicate directly with the gateway emulating a phone connection to the home phone network. The VOIP gateway will also have a second required network interface exclusive to the host application chip and the Vogarwit system.

### REMOTE HANDSET

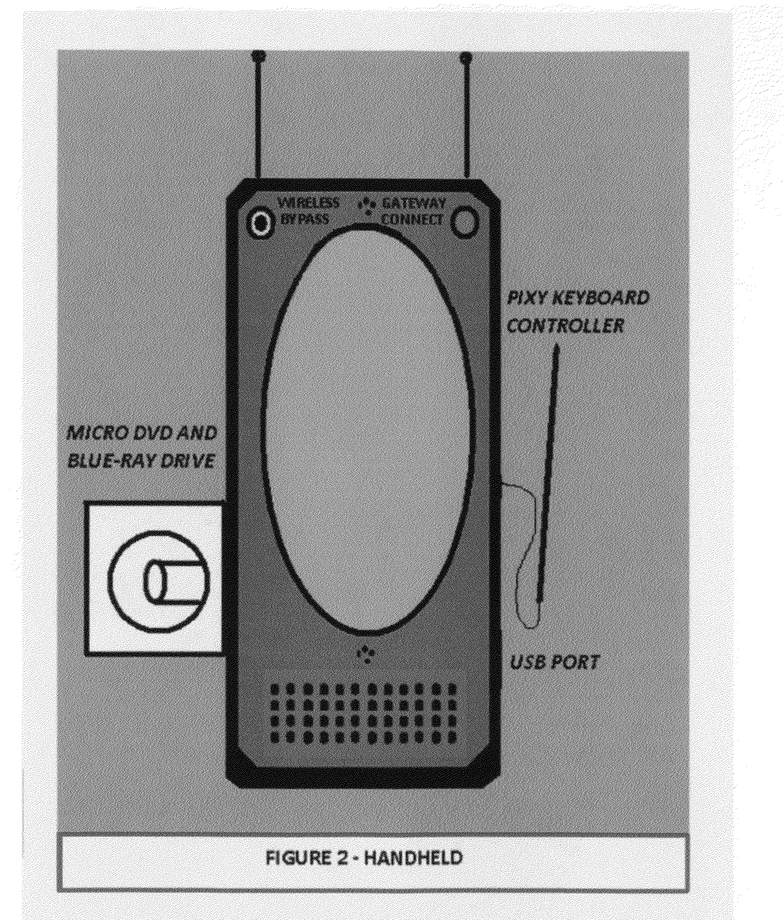

The handset (see FIG. 2) will be much like the cell phones of today with a very important difference, it will be a fully functional computer with storage, external input and user loaded applications. It will operate with a Windows or UNIX OS (operating system) with the primary application (remote Vogarwit application) loaded to the OS at boot-up. The unit will automatically begin looking for wireless connections but will provide limited functionality to the user without, although the phone function will not operate until a wireless internet enable connection is obtained. There will be as much transparency as possible however there may be user required input or login to obtain an internet enable connection. Once a connection is established the remote application begins to look for its pairing service host, once found it connects and sets the dial tone for incoming or outgoing calls. The service host application will use its own local IP address, an assigned port required to be forwarded in the router configuration assigned by the IANA (Internet Assigned Numbers Authority), and a group of dynamic ports for access when the assigned port is blocked by the wireless network managers.

The handset application will be configured by direct user interface and will be responsible for finding the service name and unique MAC broadcasted from the gateway once the handset is connected via wireless. All Vogarwit hosts will reject connection if the user set name and MAC address handshake are incorrect. The MAC address will be hard set in the handset application to the second NIC MAC in the gateway set aside for host application network access. This will help maintain security while also providing unique match between the handset and its gateway transparent to the user.

The handset will require loading of the client login interface that communicates directly with the host gateway in WINDOWS or UNIX dependant on the OS loaded but will have only one function; connecting back to its host thru static or dynamic settings. Once proper setup is completed and a connection is establish with the handset the management software locates the phone function on the handset and connects a dial tone providing any phone function established by your VOIP company contract. This system will effectively extend your home phone function to your handset and you can respond on the phone as if at home. This system provides a virtual phone extension from your home system to anywhere in the world.

1-31. (canceled)

32. The Vogarwit System is a hand held wireless computer/phone that connects through a wireless interne connection to the Vogarwit chip residing in a VoIP gateway comprising of a handset, a chip residing in a VoIP gateway and a secondary network interface card.

33. The Vogarwit System handset of claim 32 comprises an empty electronic programmable read only memory chip socket for future bypass function.

34. The empty electronic programmable read only memory chip socket of claim 33 comprises accommodations for security bypass technology for wireless phone access of the hand held unit and will be included as a functioning chip-less electronic programmable read only memory socket with chip to be installed in future system designs.

35. The Vogarwit System handset of claim 32 comprises functional capabilities of both secure and unsecure network environments.

36. The Vogarwit System handset of claim 32 comprises standard wireless security key input for wireless access unless bypass is available on the system.

37. The Vogarwit System handset of claim 32 comprises a fully functional handheld computer.

38. The fully functional handheld computer of claim 37 comprises internal storage equal to or greater than 100 gigabytes.

39. The Vogarwit System handset of claim 32 comprises a single USB port located on lower right side of unit below pixy stick.

40. The Vogarwit System handset of claim 32 comprises two SD slots for data storage and random access memory located at the back of the unit.

41. The Vogarwit System handset of claim 32 comprises a touch sense screen.

42. The Vogarwit System handset of claim 32 comprises a pixy stick protruding a quarter inch for access attached to the unit by a cable.

43. The pixy stick of claim 42 comprises an auto storage mechanism midpoint on the handset retracting the pixy stick for when the user releases it.

44. The Vogarwit System handset of claim 32 comprises a micro miniature drive slot located just below midpoint, on the left side of the handset, available for advanced micro miniature DVD and Blue Ray technology.

45. The Vogarwit System handset of claim 32 comprises power requirements satisfied by a removable onboard rechargeable 12 vdc lithium power storage cell.

46. The removable onboard rechargeable 12 vdc lithium power storage cell of claim 45 comprises a solar cell.

47. The solar cell of claim 46 comprises an external mounting on the back of the unit.

48. The removable onboard rechargeable 12 vdc lithium power storage cell of claim 45 comprises an external charging port located at the bottom of the unit and provides direct 12 volt dc connection by adaptor or automobile power tap for both charging and necessary power to run the unit.

49. The Vogarwit VoIP gateway access chip comprises a flash capable electronic programmable read only memory chip with sufficient advance design to accommodate the necessary data of the host service application.

50. The Vogarwit VoIP gateway access chip of claim 49 comprises the host service application.

51. The host service application of claim 50 comprises a software connection between the front end and back end of the Vogarwit VoIP gateway chip providing a virtual connection.

52. The Vogarwit VoIP gateway access chip of claim 49 comprises a connection to the local phone system within the gateway providing the chips physical front end.

53. The Vogarwit VoIP gateway access chip of claim 49 comprises a connection to a secondary network interface card located within the gateway providing the chips physical back end.

54. The Host Application of claim 50 comprises semi-permanent firmware loaded into the Vogarwit VoIP gateway access chip.

55. The Host Application of claim 50 comprises 128 bit encryption.

56. The Host Application of claim 50 comprises the gateway's secondary network interface card's machine address code address statically coded within it and a security handshake procedure verifying uniqueness of gateway/handset pair.

57. The VoIP gateway comprises a secondary network interface card as part of the gateways architecture secondary to the gateways primary network interface card.

58. The Network Interface Card of claim 57 comprises a data connection with the Vogarwit VoIP gateway access chip.
